(19) United States
(12) Patent Application Publication
(10) Pub. No.: US 2009/0198602 A1
(43) Pub. Date: Aug. 6, 2009

(54) RANKING COMMERCIAL OFFERS BASED ON USER FINANCIAL DATA

(75) Inventors: Gang Wang, San Diego, CA (US); Caitlin Smallwood, Palo Alto, CA (US)

Correspondence Address: PVF -- INTUIT, INC.;c/o PARK, VAUGHAN & FLEMING LLP, 2820 FIFTH STREET, DAVIS, CA, 95618-7759, US

(73) Assignee: INTUIT INC., Mountain View, CA (US)

(21) Appl. No.: 12/023,959

(22) Filed: Jan. 31, 2008

(51) Int. Cl. G06Q 40/00; G06F 17/11

(52) U.S. Cl. 705/35

(57) ABSTRACT

One embodiment of the present invention provides a system that ranks commercial offers for a user in a set of users. During operation, the system receives financial data for the set of users, wherein the financial data includes spending data for the set of users across a set of categories. Next, for a given user, the system computes an individual-strength vector based on financial data specific to the given user, wherein each entry in the individual-strength vector represents an amount of spending in a respective category for the given user. The system additionally computes a relative-strength vector for the given user based on the financial data for the set of users, wherein the relative-strength vector represents a relative-spending strength across the set of categories for the given user relative to the set of users. The system then ranks the commercial offers for a user based on both the set of individual-strength vectors and the set of relative-strength vectors for the set of users.

### BACKGROUND

### Related Art

The present invention relates to the design of recommendation systems.

In the multi-billion-dollar online advertising market, a new type of web application referred to as a “recommendation system” targets online users through personalized and data-driven recommendation techniques. Specifically, a recommendation system learns from the online activities of a large number of users and makes recommendations to users based on the observed interests of these users.

There exist many different types of recommendation systems which use different approaches to make recommendations. A “content-based” approach makes recommendations based on user profile data. In this approach, user information is first either explicitly or implicitly collected. Next, this user information is used to generate user-relevant recommendations. However, while making recommendations to users, a content-based recommendation system generally does not perform correlations or cross-references between user-specific profiles and a user's community.

In contrast, a “collaborative-filtering” approach makes recommendations based on community similarities. More specifically, in this approach recommendations are made based on “popularity” derived from data aggregation and ranking. Note that in this approach, user-specific profile information is generally ignored. Moreover, no correlations or cross-references are performed between the user profiles and community recommendations.

A hybrid approach combines the previous two approaches. For example, a hybrid approach can aggregate the online behavior of a large number of people to identify trends and can then make recommendations based on these trends. Note that the hybrid approach essentially constructs smaller groups within the overall community, and individuals are classified into such groups based on the similarities of their behaviors. Subsequently, social information extracted from these refined groups can be used to make suggestions to a specific user. One highly visible example of the hybrid approach is the Amazon web site. In addition to making recommendations based on the user-specific browsing/purchasing/wish-list history, Amazon aggressively uses community information to make relevant recommendations to consumers.

Unfortunately, the hybrid approach has a drawback. Because of the lack of complete and accurate user spending data, systems which employ the hybrid approach typically use an item-to-item-collaborative-filtering technique, which is limited to the purchases made on a specific site. For example, in the case of Amazon, the recommendation engine is limited to the purchase records and/or interactions users have made within the Amazon web site. This restriction can limit the relevancy and effectiveness of recommendations made by such systems.

### SUMMARY

One embodiment of the present invention provides a system that ranks commercial offers for a user in a set of users based on users' financial data. In particular, the users' financial data can include spending history data, which can include, but is not limited to bank account activities, credit card purchases, and other spending activities. During operation, the system receives financial data for the set of users, wherein the financial data includes spending data for the set of users across a set of categories. Next, for a given user, the system computes an individual-strength vector based on financial data specific to the given user, wherein each entry in the individual-strength vector represents an amount of spending in a respective category for the given user. The system additionally computes a relative-strength vector for the given user based on the financial data for the set of users, wherein the relative-strength vector represents a relative-spending strength across the set of categories for the given user relative to the set of users. The system then ranks the commercial offers for a user based on both the set of individual-strength vectors and the set of relative-strength vectors for the set of users.

In a variation on this embodiment, the system computes the individual-strength vector for the given user by first classifying the spending data for the given user into the set of categories. The system then generates a vector entry for each of the set of categories by: computing a total amount of spending within the category and normalizing the total amount of spending within the category to a total amount of spending for the given user across the set of categories.

In a variation on this embodiment, prior to computing the relative-strength vector, the system classifies the spending data for the set of users into the set of categories so that each category is associated with a set of spending records for the set of users. Next, for each category, the system creates a set of bins, wherein each bin represents an interval of spending strength for the category. The system then generates a histogram by classifying and aggregating the set of users into the set of bins based on the set of spending records. Next, the system generates a probability distribution function for the category from the histogram. Note that the system generates a probability distribution function for each category in the set of categories.

In a further variation, the system computes the relative-strength vector for the given user by generating a vector entry for each category in the set of categories by computing a position of the given user in a corresponding probability distribution function.

In a further variation, the spending strength can be measured as absolute amount of spending in the category or a percentage of spending in the category relative to the total spending across the set of categories.

In a variation on this embodiment, prior to ranking the commercial offers, the system forms a spending vector for the given user by combining the individual-strength vector and the relative-strength vector for the given user.

In a further variation, the system ranks each commercial offer by: (1) generating a set of initial ranking scores for the set of users based on the set of individual-strength vectors associated with the set of users; (2) computing a set of weights for the set of initial ranking scores by computing differences between the spending vector associated with the user and the spending vectors associated with each of the set of users; and (3) computing a final ranking score for the user based on the set of initial ranking scores and the set of weights.

In a further variation, the system generates an initial ranking score for a user by classifying the commercial offer into a corresponding category in the set of categories and determining the initial ranking score for the user based on the value of an entry for the corresponding category in the associated individual-strength vector.

In a further variation, the system determines the initial ranking score for the user based on the value of the entry by assigning a larger initial ranking score if the value of the entry indicates a larger amount of spending in the corresponding category relative to other categories for the given user.

In a further variation, the system computes a difference between a pair of spending vectors by computing a distance between the pair of spending vectors, wherein a smaller distance indicates a stronger similarity between the pair of spending vectors

In a further variation, the distance between the pair of spending vectors can be measured by: a Euclidean distance; a Manhattan distance; Pearson coefficients; and other vector-distance measures.

In a further variation, the system computes the final ranking score R(u, o) of the commercial offer o for the user u based on the set of initial ranking scores and the set of weights by aggregating a set of weighted initial ranking scores by using the expression: R(u,o)=κΣ_{u′εN} sim(u,u′)×R(u′,o), wherein κ is a normalization constant, u′ is a user in the set of users N, R(u′, o) is the initial ranking score of the commercial offer o for the user u′, and sim(u, u′) is the distance between the spending vectors associated with the users u and u′.

In a variation on this embodiment, both the individual-strength vector and the relative-strength vector are time-dependent vectors.

In a variation on this embodiment, the financial data for a user in the set of users can include information of frequency of transactions; number of transactions; time interval between transactions; and amount per transaction.

### BRIEF DESCRIPTION OF THE FIGURES

FIG. 1 illustrates a computing environment for a recommendation system in accordance with an embodiment of the present invention.

FIG. 2 presents a flowchart illustrating the process of ranking a pool of commercial offers for a set of users in accordance with an embodiment of the present invention.

FIG. 3 presents a flowchart illustrating the process of computing an individual-spending-strength vector based on user spending data in accordance with an embodiment of the present invention.

FIG. 4 presents a flowchart illustrating the process of computing a relative-spending-strength vector for a given user based on the user spending data in accordance with an embodiment of the present invention.

FIG. 5 presents a flowchart illustrating the process of ranking an offer for a given user in the set of users in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

### Terminology

Throughout the specification, the terms “financial data,” “financial history,” “financial history data,” “user financial data,” “user financial history,” and “user financial history data,” are all used interchangeably. Furthermore, the terms “spending data,” “spending history,” “spending records,” “user spending data,” “user spending history,” and “user spending records” are also used interchangeably. Moreover, the terms “commercial offers,” and “offers” are used interchangeably.

### Overview

One embodiment of the present invention provides a recommendation system for generating highly relevant and personalized recommendations on commercial offers to users. In some embodiments of the present invention, the recommendation system generates personalized rankings for a large number of commercial offers based on a user's financial history data, including spending records (e.g., from a Quicken data file), and makes recommendations to the user based on the personalized rankings. In some embodiments of the present invention, the recommendation system generates high relevancy and highly personalized rankings for the commercial offers based on financial history data (including spending records) from a population of users, and makes recommendations to each of the users based on the high relevancy and highly personalized rankings for each user.

We presently describe: (1) how the recommendation system characterizes the user's spending records in a compact computational representation; (2) how to compare differences between different users based on the above representation; (3) and how to rank different commercial offers for different users based on the above representation and the differences between the representations for different users.

### Computing Environment for a Recommendation System

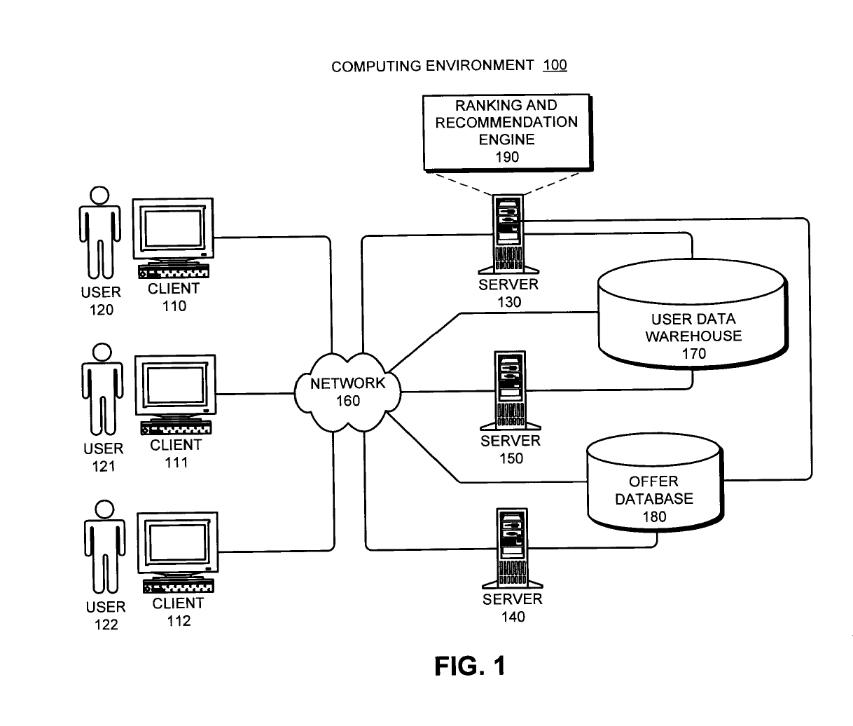

FIG. 1 illustrates a computing environment 100 for a recommendation system in accordance with an embodiment of the present invention. Computing environment 100 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 1, computing environment 100 includes clients 110-112, users 120-122, servers 130-150, network 160, user data warehouse 170, and offer database 180.

Clients 110-112 can include any node on a network including computational capability and including a mechanism for communicating across the network.

Similarly, servers 130-150 can generally include any node on a network including a mechanism for servicing requests from a client for computational and/or data storage resources.

Users 120-122 can include: an individual; a group of individuals; an organization; a group of organizations; a computing system; a group of computing systems; or any other entity that can interact with computing environment 100. In one embodiment of the present invention, users 120-122 are individual users targeted by the recommendation system.

Network 160 can include any type of wired or wireless communication channel capable of coupling together computing nodes. This includes, but is not limited to, a local area network, a wide area network, or a combination of networks. In one embodiment of the present invention, network 160 includes the Internet. In some embodiments of the present invention, network 160 includes phone and cellular phone networks.

User data warehouse 170 can include any type of system for storing user financial data in non-volatile storage. This includes, but is not limited to, systems based upon magnetic, optical, or magneto-optical storage devices, as well as storage devices based on flash memory and/or battery-backed up memory. Note that user data warehouse 170 can be coupled to one or more servers (such as servers 130 and 150), to a client, and to network 160. In some embodiments of the present invention, user data warehouse 170 can store financial and non-financial data for users 120-122. This financial and non-financial data can include, but is not limited to, user financial history data, user financial transaction history data, user spending data, user income data, user tax data, search history data, commercial offer viewing data, click data and print history data. Note that some of the above data can be directly obtained from a user's financial software data file or from a user's financial intuitions. Note that both the financial and non-financial data can be updated periodically or in real time.

Offer database 180 can include any type of system for storing commercial offers in non-volatile storage. This includes, but is not limited to, systems based upon magnetic, optical, or magneto-optical storage devices, as well as storage devices based on flash memory and/or battery-backed up memory. Note that user offer database 180 can be coupled to one or more servers (such as servers 130 and 140), to a client, and to network 160. Note that the commercial offers in offer database 180 can be updated periodically or in real time.

Also note that server 130 comprises a ranking and recommendation engine 190. When executed on server 130, ranking and recommendation engine 190 can compute rankings for commercial offers stored in offer database 180 for users 120-122, and these rankings can be based on financial and non-financial data stored in user data warehouse 170. Additionally, ranking and recommendation engine 190 can send and display offers selected for users 120-122 on clients 110-112. We now describe the ranking function of ranking and recommendation engine 190 in more detail below.

Note that different embodiments of the present invention may use different configurations, and are not limited to the configuration illustrated in computing environment 100.

### Ranking Commercial Offers—Overview

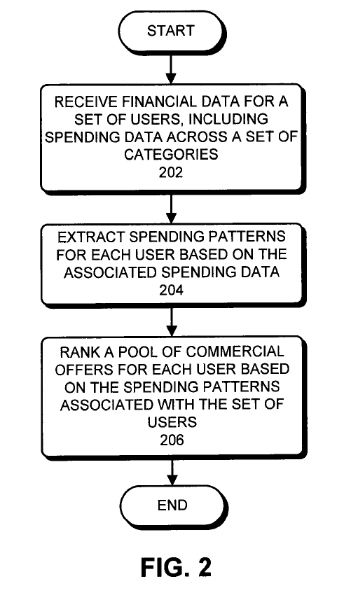

FIG. 2 presents a flowchart illustrating the process of ranking a pool of commercial offers for a set of users in accordance with an embodiment of the present invention. Note that each offer in the pool can belong to any spending category within a set of spending categories (referred to as “categories” hereafter) used to classify user spending data. Examples of categories can include, but are not limited to, groceries, utilities/cable, transportation, household expenses, and entertainment. Note that the categories are often set up in financial software to automatically track and sort financial transactions.

During operation, the system starts by receiving financial data for a set of users, wherein the financial data includes spending data for the set of users across a set of categories (step 202). In one embodiment, the system can retrieve user financial data from user data warehouse 170. Note that the financial data for a user can include financial transaction information, which can include, but is not limited to frequency of transactions, number of transactions, time interval between transactions, and amount per transaction. Note that the financial data for a user can change with time, for example, by adding new financial transactions. Also note that financial transactions can include, but are not limited to, transactions involving a credit card, cash, a check, a money order, or any other financial instrument. In some embodiments of the present invention, the system can directly retrieve the financial data for a user from the user's financial software data file.

In some embodiments, the user spending data comprises multiple spending items across a set of categories accumulated over a period of time (e.g., for the last six months), wherein each spending item may be classified into one or more of the categories. Note that the spending data for a user can include at least two attributes: a first attribute indicating personal spending behavior, which is referred to as “individual-spending-strength” below; and a second attribute indicating social or financial association with a group of users of similar background, which is referred to as “relative-spending-strength” below.

Referring back to FIG. 2, the system next extracts spending patterns for each user based on the associated spending data (step 204). In one embodiment of the present invention, extracting spending patterns involves constructing a computational representation from the spending data for a user. Note that the computational representation for the spending data can facilitate: (1) comparing spending data associated with different users on the same platform; (2) mathematically manipulating the spending data; and (3) identifying attributes in the spending data. In one embodiment of the present invention, constructing the computational representation involves separately computing an “individual-spending-strength vector” and a “relative-spending-strength vector” for each user based on the user spending data. (We describe the process of computing these spending vectors in more detail below.)

Next, the system ranks the pool of commercial offers for each user in the set of users based on the spending patterns associated with the set of users (step 206). More specifically, the system ranks the commercial offers for the user based on both the user's individual-spending-strength vector and the user's relative-spending-strength vector. Note that offers that are more relevant to the user generally receive higher ranking scores in this process. (We describe this ranking process in more detail below.)

Finally, the system can make recommendations to the users based on the rankings of these offers.

### Computing Individual-Spending-Strength Vectors

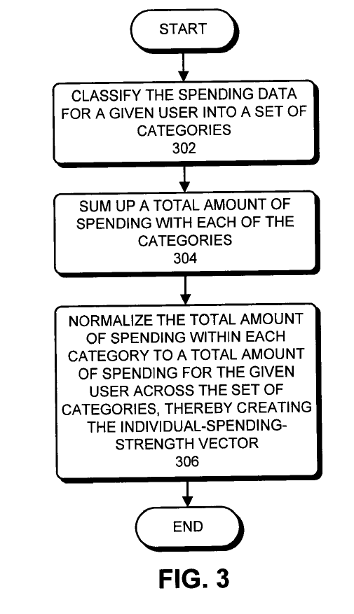

FIG. 3 presents a flowchart illustrating the process of computing an individual-spending-strength vector based on user spending data in accordance with an embodiment of the present invention.

During operation, the system classifies the spending data for the given user into the set of categories (step 302). More specifically, this involves classifying each spending item into a corresponding category. In some embodiments, the corresponding category can be determined based on tags or names, or based on store names associated with the spending items. For example, items with the store names “Target” and “JCPenny” can be classified into one category, while items associated with “McDonald's” and “Taco Bell” can be classified into another category. Note that the set of categories can be a predetermined set of categories. In some embodiments, new categories can be created during this categorization process. For example, if a spending item does not belong to any of the existing categories, a new category can be created for the spending item. In some embodiments, one category may comprise one or more subcategories to facilitate more detailed categorization.

Next, for each of the categories, the system sums up a total amount of spending within the category (step 304). Note that a category can be empty if the user does not spend money on that category. Also note that a single large transaction in one category may not necessarily indicates the user's preference in that category. For example, the sum of a large number of smaller transactions in one category over a predetermined time period may be significantly larger than a single large transaction in another category within the same time period.

The system next normalizes the total amount of spending within each category to a total amount of spending for the given user across the set of categories (step 306). In one embodiment, the system can compute a percentage value for each category over the total amount of spending across all categories. Note that through this normalization process, variations in the absolute amount of spending over the set of categories by different users are also normalized.

Note that upon normalization, an individual-spending-strength vector is created, wherein each entry in the individual-spending-strength vector represents a normalized individual-amount-of-spending in a respective category for the given user. This vector representation allows personal spending behaviors for different users to be easily compared and measured. Note that users associated with similar spending behaviors receive similar individual-spending-strength vectors. For example, two users who both spend evenly across the categories would have similar individual-spending-strength vectors.

Note that the above process is described in terms of a single user. However, this process can be repeated for all users in the set of users to generate individual-spending-strength vectors for the entire set of users.

### Computing Relative-Spending-Strength Vectors

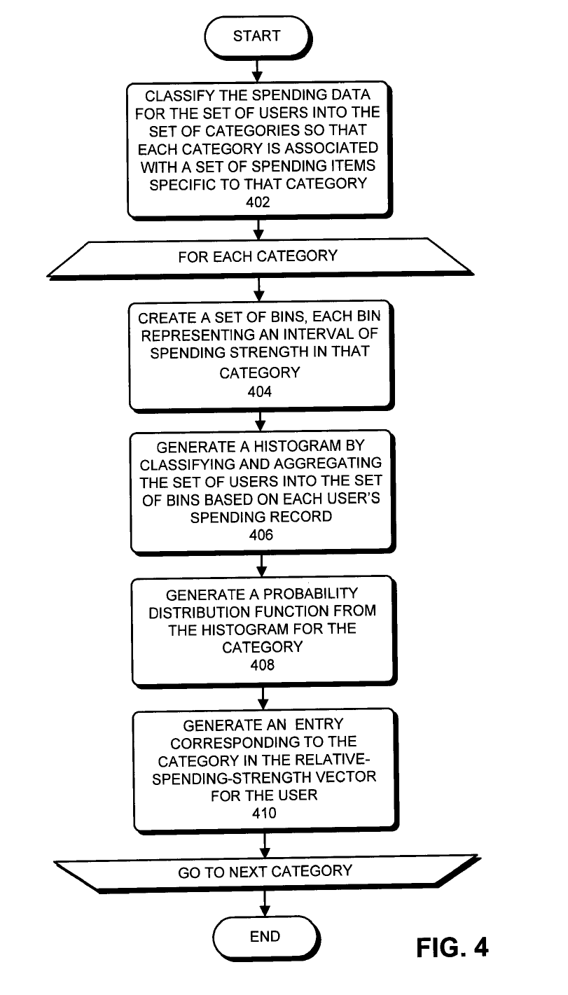

FIG. 4 presents a flowchart illustrating the process of computing a relative-spending-strength vector for a given user based on the user spending data in accordance with an embodiment of the present invention.

During operation, the system starts by classifying spending data for the set of users into the set of categories so that each category is associated with a set of spending items specific to that category (step 402). Note that this step is similar to step 302 in FIG. 3 except that we perform the categorization for a population of users.

Next, for each of the categories, the system creates a set of bins, wherein each bin represents an interval of spending strength in that category (step 404). Note that the set of bins provides a measurement of the relative spending strength. In one embodiment, the set of bins can be represented by an absolute amount of spending in that category for a user. For example, the set of bins can be defined as a set of intervals: B1: $0-$100; B2: $100-$250; B3: $250-$500; B4: $500-$1000, etc. In another embodiment, the set of bins is represented by a percentage of spending which equals the absolute amount of spending in that category divided by the total spending across the set of categories for a user. For example, the set of bins can be defined as a set of intervals: B1: 0-5%; B2: 5%-%10; B3: 10%-15%; B4: 15%-20%, etc.

The system then generates a histogram by classifying and aggregating the set of users into the set of bins based on each user's spending record (step 406). For example, if bin intervals are defined based on the absolute amount of spending, a user who spends $200 in the category is aggregated into B2 for that category (typically by incrementing the number count in the bin by 1) in the above-described example.

Next, the system generates a probability distribution from the histogram for the category (step 408). In one embodiment, the probability distribution can be generated from the histogram by curve fitting. In one embodiment, the curve fitting can assume a Gaussian distribution for the histogram. In this embodiment, the obtained probability distribution function is a Gaussian function with mean μ and standard deviation σ. In other embodiments, other distributions for the histogram may be assumed.

The system next generates a value for the vector entry corresponding to the category in the relative-spending-strength vector for the user by computing a position of the user in the probability distribution function (step 410). In one embodiment, the entry value can be computed as (X−μ)/σ; wherein X is the quantity of the bin the user is associated with.

The system then repeats steps 404-410 for the set of categories to generate a set of probability distributions, and generates individual vector elements to create the entire relative-spending-strength vector. Furthermore, steps 404-410 can be repeated for each user in the set of users to create a set of relative-spending-strength vectors for each user in the set of users.

Note that the relative-spending-strength vector can be viewed as an indicator of a user's financial and social background. In some embodiments, in additional to the spending data, a relative-spending-strength vector can also include entries representing other financial information. For example, one entry can be created based on user income, and other entries can be created based on a user's tax filing data. Hence, the structure of the relative-spending-strength vector is not limited to the embodiment illustrated in FIG. 4.

In one embodiment of the present invention, prior to ranking the commercial offers, the system forms a “spending vector” for each user by combining the individual-spending-strength vector and the relative-spending-strength vector for the user. The system can similarly generate a set of spending vectors for each user in the set of users.

### Ranking Commercial Offers Based on Spending Vectors

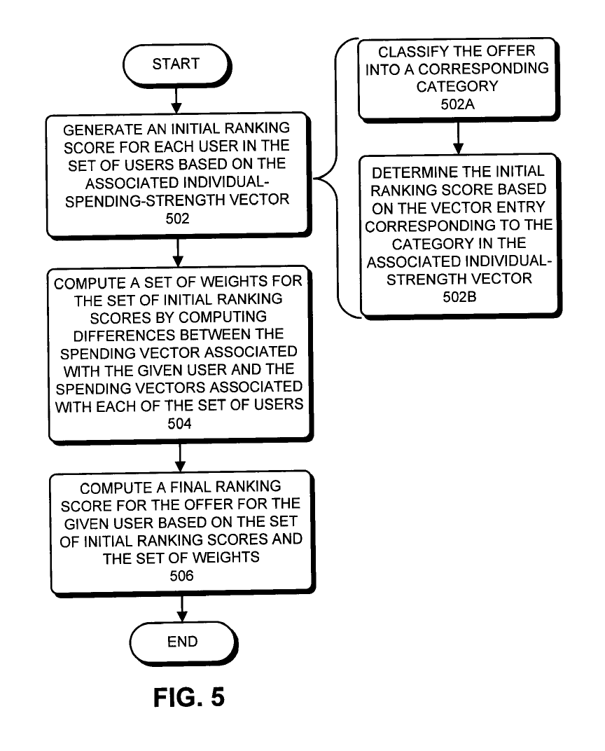

Note that each offer in a pool of offers can be ranked independently without affecting the rankings of other offers. Hence, we only need to describe the process of ranking a particular offer. FIG. 5 presents a flowchart illustrating the process of ranking an offer for a given user in the set of users in accordance with an embodiment of the present invention.

During operation, the system generates an initial ranking score for each user in the set of users based on an associated individual-spending-strength vector (step 502). More specifically, to generate an initial ranking score for a user, the system classifies the commercial offer into one or more corresponding categories in the set of categories (step 502A). Note that the step 502A is similar to step 302 in FIG. 3 except that step 302 classifies the user spending data instead of a commercial offer. Next, the system determines the initial ranking score for the user based on the vector entry corresponding to the corresponding category in the associated individual-spending-strength vector (step 502B). In one embodiment, the system assigns a larger initial ranking score if the value of the entry indicates a larger amount of spending in the corresponding category relative to other categories for the user. Note that step 502 generates a set of initial ranking scores for the same offer, wherein the set of initial ranking scores can be different for different users.

Note that these initial ranking scores provide a rough estimate of how “interesting” the offer is to a specific user. More importantly, this step solves the infamous “new user” problem in conventional recommendation systems in a straightforward way and does not require the user to accumulate interaction data with the system which typically takes a long time.

Referring back to FIG. 5, the system next computes a set of weights for the set of initial ranking scores by computing differences between the spending vector associated with the given user and the spending vectors associated with each of the set of users (step 504). In one embodiment of the present invention, while computing a difference between a pair of spending vectors, a smaller distance indicates a stronger similarity between the pair of spending vectors and hence the pairs of users. Note that different distance measures can be used to compute the vector distances, which can include, but are not limited to, Euclidean distance, Manhattan distance, Pearson coefficients and other vector-distance measures.

In some embodiments, other than defining the weights as distances between the spending vectors (individual-spending-strength vector+relative-spending-strength vector), weights can also be computed based on the distance between the individual-spending-strength vectors for two users, or the distance between the relative-spending-strength vectors for two users.

Referring back to FIG. 5, the system next computes a final ranking score for the offer for the given user based on the set of initial ranking scores and the set of weights (step 506). More specifically, the final ranking score is computed by aggregating the weighted initial ranking scores over the set of users (e.g., all the users in the system). Recall that the weights can be the distances between the spending vector of the user under consideration and the other users in this population. This final ranking score essentially represents a collective vote based on the community data in the system.

Furthermore, determined similarities between users can facilitate evaluating contributions. If two users have similar spending patterns, they can have similar spending vectors. Consequently, these two users have a smaller distance between their respective vectors, which yields a higher weight for the corresponding contribution. Note that the final ranking scores significantly increase the relevancy of the initial ranking scores to a given user.

In one embodiment, we can express the above-described final ranking score in mathematical terms. Specifically, a final ranking score R(u, o) of a commercial offer o for a user u can be computed by aggregating a set of initial ranking scores and the set of weights using the expression:

R(u,o)=κΣ_{u′εN}sim(u,u′)×R(u′,o),

wherein κ is a normalization constant, u′ is a user in the set of users N, R(u′, o) is the initial ranking score of the commercial offer o for the user u′, and sim(u, u′) is the distance between the spending vectors associated with the users u and u′.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A method for ranking commercial offers for a user in a set of users, comprising:
receiving a commercial offer for the set of users;
receiving financial data for the set of users, wherein the financial data includes spending data for the set of users across a set of categories;
for a given user in the set of users:
computing an individual-strength vector based on the financial data specific to the given user, wherein each entry in the individual-strength vector represents an amount of spending in a respective category for the given user; and
computing a relative-strength vector based on the financial data for the set of users, wherein the relative-strength vector represents a relative-spending-strength across the set of categories for the given user relative to the set of users; and
computing a ranking score of the commercial offer for a user in the set of users based on both the set of individual-strength vectors and the set of relative-strength vectors for the set of users, wherein computing the ranking score involves computing a set of differences in spending strength between the user and each of the set of users.

2. The method of claim 1, wherein computing the individual-strength vector for the given user involves:
classifying the spending data for the given user into the set of categories; and
generating a vector entry for each of the set of categories by:
computing a total amount of spending within the category; and
normalizing the total amount of spending within the category to a total amount of spending for the given user across the set of categories.

3. The method of claim 1, wherein prior to computing the relative-strength vector, the method further comprises:
classifying spending data for the set of users into the set of categories so that each category is associated with a set of spending records for the set of users; and
for each category,
creating a set of bins, wherein each bin represents an interval of spending strength for the category;
generating a histogram by classifying and aggregating the set of users into the set of bins based on the set of spending records; and
generating a probability distribution function from the histogram.

4. The method of claim 3, wherein computing the relative-strength vector for the given user involves generating a vector entry value for each category in the set of categories by computing a position of the given user in a corresponding probability distribution function.

5. The method of claim 3, wherein the spending strength can be measured by:
an absolute amount of spending in the category; or
a percentage of spending in the category relative to the total spending across the set of categories.

6. The method of claim 1, wherein prior to computing the ranking score, the method further comprises forming a spending vector for the given user by combining the individual-strength vector and the relative-strength vector, thereby generating a set of spending vectors for the set of users.

7. The method of claim 6, wherein for each commercial offer, computing the ranking score for the user involves:
generating a set of initial ranking scores for the set of users based on the set of individual-strength vectors associated with the set of users;
computing a set of weights for the set of initial ranking scores by computing differences between the spending vector associated with the user and the spending vectors associated with each of the set of users; and
computing a final ranking score for the user based on the set of initial ranking scores and the set of weights.

8. The method of claim 7, wherein generating an initial ranking score for a user in the set of users involves:
classifying the commercial offer into a corresponding category in the set of categories; and
determining the initial ranking score for the user based on the value of an entry for the corresponding category in the associated individual-strength vector.

9. The method of claim 8, wherein determining the initial ranking score for the user based on the value of the entry involves assigning a larger initial ranking score if the value of the entry indicates a larger amount of spending in the corresponding category relative to other categories for the given user.

10. The method of claim 7, wherein computing a difference between a pair of spending vectors involves computing a distance between the pair of spending vectors, wherein a smaller distance indicates a stronger similarity between the pair of spending vectors.

11. The method of claim 10, wherein the distance between the pair of spending vectors can be measured by:
a Euclidean distance;
a Manhattan distance;
Pearson coefficients; and
other vector-distance measures.

12. The method of claim 10, wherein computing the final ranking score R(u, o) of the commercial offer o for the user u based on the set of initial ranking scores and the set of weights involves aggregating a set of weighted initial ranking scores by using the expression:
R(u, o)=KΣ_{u′∈N}sim(u, u′)×R(u′, o)
wherein K is a normalization constant, u′ is a user in the set of users N, R(u′, o) is the initial ranking score of the commercial offer o for the user u′, and sim(u, u′) is the distance between the spending vectors associated with the users u and u′.

13. The method of claim 1, wherein both the individual-strength vector and the relative-strength vector are time-dependent vectors.

14. The method of claim 1, wherein the financial data for a user in the set of users can include information of:
frequency of transactions;
number of transactions;
time interval between transactions; and
amount per transaction.

15. A computer-readable storage medium storing instructions that when executed by a computer cause the computer to perform a method for ranking commercial offers for a user in a set of users, the method comprising:
receiving a commercial offer for the set of users;
receiving financial data for the set of users, wherein the financial data includes spending data for the set of users across a set of categories;
for a given user in the set of users:
computing an individual-strength vector based on the financial data specific to the given user, wherein each entry in the individual-strength vector represents an amount of spending in a respective category for the given user; and
computing a relative-strength vector based on the financial data for the set of users, wherein the relative-strength vector represents a relative-spending-strength across the set of categories for the given user relative to the set of users; and
computing a ranking score of the commercial offer for a user in the set of users based on both the set of individual-strength vectors and the set of relative-strength vectors for the set of users, wherein computing the ranking score involves computing a set of differences in spending strength between the user and each of the set of users.

16. The computer-readable storage medium of claim 15, wherein computing the individual-strength vector for the given user involves:
classifying the spending data for the given user into the set of categories; and
generating a vector entry for each of the set of categories by:
computing a total amount of spending within the category; and
normalizing the total amount of spending within the category to a total amount of spending for the given user across the set of categories.

17. The computer-readable storage medium of claim 15, wherein prior to computing the relative-strength vector, the method further comprises:
classifying spending data for the set of users into the set of categories so that each category is associated with a set of spending records for the set of users; and
for each category,
creating a set of bins, wherein each bin represents an interval of spending strength for the category;
generating a histogram by classifying and aggregating the set of users into the set of bins based on the set of spending records; and
generating a probability distribution function from the histogram.

18. The computer-readable storage medium of claim 17, wherein computing the relative-strength vector for the given user involves generating a vector entry value for each category in the set of categories by computing a position of the given user in a corresponding probability distribution function.

19. The computer-readable storage medium of claim 17, wherein the spending strength can be measured by:
an absolute amount of spending in the category; or
a percentage of spending in the category relative to the total spending across the set of categories.

20. The computer-readable storage medium of claim 15, wherein prior to computing the ranking score, the method further comprises forming a spending vector for the given user by combining the individual-strength vector and the relative-strength vector, thereby generating a set of spending vectors for the set of users.

21. The computer-readable storage medium of claim 20, wherein for each commercial offer, computing a ranking score for the user involves:
generating a set of initial ranking scores for the set of users based on the set of individual-strength vectors associated with the set of users;
computing a set of weights for the set of initial ranking scores by computing differences between the spending vector associated with the user and the spending vectors associated with each of the set of users; and
computing a final ranking score for the user based on the set of initial ranking scores and the set of weights.

22. The computer-readable storage medium of claim 21, wherein generating an initial ranking score for a user in the set of users involves:
classifying the commercial offer into a corresponding category in the set of categories; and
determining the initial ranking score for the user based on the value of an entry for the corresponding category in the associated individual-strength vector.

23. The computer-readable storage medium of claim 22, wherein determining the initial ranking score for the user based on the value of the entry involves assigning a larger initial ranking score if the value of the entry indicates a larger amount of spending in the corresponding category relative to other categories for the given user.

24. The computer-readable storage medium of claim 21, wherein computing a difference between a pair of spending vectors involves computing a distance between the pair of spending vectors, wherein a smaller distance indicates a stronger similarity between the pair of spending vectors.

25. The computer-readable storage medium of claim 24, wherein the distance between the pair of spending vectors can be measured by:
a Euclidean distance;
a Manhattan distance;
Pearson coefficients; and
other vector-distance measures.

26. The computer-readable storage medium of claim 24, wherein computing the final ranking score R(u, o) of the commercial offer o for the user u based on the set of initial ranking scores and the set of weights involves aggregating a set of weighted initial ranking scores by using the expression:
R(u, o)=KΣ_{u′∈N}sim(u, u′)×R(u′, o),
wherein K is a normalization constant, u′is a user in the set of users N, R(u′, o) is the initial ranking score of the commercial offer o for the user u′, and sim(u, u′) is the distance between the spending vectors associated with the users u and u′.

27. The computer-readable storage medium of claim 15, both the individual-strength vector and the relative-strength vector are time-dependent vectors.

28. The computer-readable storage medium of claim 15, wherein the financial data for a user in the set of users can include information of:
frequency of transactions;
number of transactions;
time interval between transactions; and
amount per transaction.

29. A system that ranks commercial offers for a user in a set of users, comprising:
a receiving mechanism configured to:
receive a commercial offer for the set of users; and
receive financial data for the set of users, wherein the financial data includes spending data for the set of users across a set of categories;
a computing mechanism configured to compute for a given user in the set of users:
an individual-strength vector based on the financial data specific to the given user, wherein each entry in the individual-strength vector represents an amount of spending in a respective category for the given user; and
a relative-strength vector based on the financial data for the set of users, wherein the relative-strength vector represents a relative-spending-strength across the set of categories for the given user relative to the set of users; and
where the computing mechanism is further configured to compute a ranking score of a commercial offer for a user in the set of users based on both the set of individual-strength vectors and the set of relative-strength vectors for the set of users,
wherein computing the ranking score involves computing a set of differences in spending strength between the user and each of the set of users.
